(19) United States
(12) Patent Application Publication
(10) Pub. No.: US 2015/0261394 A1
(43) Pub. Date: Sep. 17, 2015

(54) DEVICE AND METHOD FOR DISPLAYING MENU ITEMS

(71) Applicants: Sandeep Shah, Northborough, MA (US); Kartik Shah, Nashua, NH (US)

(72) Inventors: Sandeep Shah, Northborough, MA (US); Kartik Shah, Nashua, NH (US)

(21) Appl. No.: 14/660,909

(22) Filed: Mar. 17, 2015

Related U.S. Application Data
(60) Provisional application No. 61/954,574, filed on Mar. 17, 2014.

(51) Int. Cl. G06F 3/0482; G06F 3/0487; G06F 3/0484

(52) U.S. Cl. CPC G06F 3/0482; G06F 3/04842; G06F 3/0487

(57) ABSTRACT

A method and apparatus for presenting a plurality of menu items on a display screen of a computing device is disclosed. The method involves a computing device programmed to display computerized graphical icons in an elastic menu strip on a display screen, and extending the elastic menu strip to include additional computerized graphical icons in a limited display screen size. The additional computerized graphical icons are presented in an additional elastic menu strip which is added as an extension to the elastic menu strip. The extension accommodates more computerized graphical icons to be displayed on the display screen and enables the activation and selection of the menu items in a single touch action.

### CROSS-REFERENCE TO RELATED APPLICATIONS

This application is a non-provisional application which claims the benefit to Provisional Application No. 61/954,574 filed on Mar. 17, 2014.

### BACKGROUND

1. Field of the Invention

The present invention relates generally to methods for displaying menu items in display screens of computing devices. More particularly the present invention relates to a method of display screening and managing menu items on a graphical computerized user interface.

2. Description of Related Art

Many electronic devices with display screens are becoming more compact, this is especially the case in mobile computing devices. In addition, as the features and functions of the computing devices increase, more programs are being stored in the computing device which generates more icons to be displayed on the display screen. In turn, users have difficulty managing and controlling the abundance of icons.

This situation is unfortunate because the computerized user interface is the gateway through which the users enjoy the latest technologies and convenience of computing devices on a daily basis. Moreover, the conventional method of display screening icons and list of items on a display screen is not intuitive and not flexible. The user does not have much freedom in the placement of the icons and there arrangements within the limits of the display screen size. In addition, when the user needs to select an item from a choice of many, the user is subjected to clicking or tapping on the screen multiple times while having to scroll through a large selection occupying a large screen area.

Therefore, what is needed is a system and method that increases the usability of the items or icons being displayed on a display screen. There also is a need for a system and method that accommodates arrangement of the items or icons in a limited display screen size, while reducing the complexity of actuations required by a user input pointing device to control the items or icons.

### SUMMARY

The subject matter of this application may involve, in some cases, interrelated products, alternative solutions to a particular problem, and/or a plurality of different uses of a single system or article.

In one aspect, a method of presenting a plurality of menu items on a display screen of a computing device is disclosed. The method may begin with one or more processors presenting the plurality of menu items on the display screen, in response to a menu activation area being triggered. The display screen may comprise the menu activation area. The menu activation area may be triggered in response to a detector unit detecting a first cursor actuation from a cursor of a user input pointing device at the menu activation area. The user input pointing device and the detector unit may be in communication with the one or more processors.

The one or more processors may arrange the plurality of menu items on the display screen within an elastic menu strip. The elastic menu strip may be sized and positioned on the display screen based on at least one of the following factors: size of the display screen, orientation of the display screen, available area of the display screen, number of the plurality of menu items, and size of each of the plurality of menu items. The one or more processors may further display an additional elastic menu strip by adding the additional elastic menu strip as an extension to the elastic menu strip, to present at least one additional menu item contained within the additional elastic menu strip on the display screen. The additional elastic menu strip may be displayed in response to an overflow trigger being activated by the cursor of the user input pointing device. The plurality of menu items may comprise the overflow trigger.

In another aspect, a device for presenting a plurality of menu items is disclosed. The device may comprise a display screen, a storage unit storing an instruction, and one or more processors in communication with the display screen and the storage unit to execute the instruction in the storage unit.

The one or more processors may present the plurality of menu items on the display screen, in response to a menu activation area being triggered, where the display screen comprises the menu activation area. A detector unit detecting a first cursor actuation from a cursor of a user input pointing device at the menu activation area may trigger the menu activation area. The user input pointing device and the detector unit may be in communication with the one or more processors. The plurality of menu items on the display screen may be arranged within an elastic menu strip. The elastic menu strip may be sized and positioned on the display screen based on at least one of the following factors: size of the display screen, orientation of the display screen, available area of the display screen, number of the plurality of menu items, and size of each of the plurality of menu items. Further, an additional elastic menu strip may be added as an extension to the elastic menu strip to present at least one additional menu item contained within the additional elastic menu strip. The additional elastic menu strip may be presented in response to an overflow trigger being activated, where the plurality of menu items comprises the overflow trigger.

In yet another aspect, a non-transitory computer readable medium storing executable instructions to carry out a method of presenting a plurality of menu items on a display screen of a computing device is disclosed. The executable instructions, when executed, may cause one or more processors to perform the method of presenting a plurality of menu items on a display screen. The one or more processors may be in communication with each other via a network and with a storage unit.

### BRIEF DESCRIPTION OF THE DRAWINGS

FIG. 1 provides an embodiment of the display screen being presented by a touchscreen device.

FIG. 2 provides an embodiment of the elastic menu strip being displayed on the display screen.

FIG. 3A provides an exemplary embodiment of the elastic menu strip in the overflow state.

FIG. 3B provides another exemplary embodiment of the elastic menu strip in the overflow state.

FIG. 4 provides an embodiment showing one of the plurality of menu items being selected from the elastic menu strip.

FIG. 5 provides an exemplary embodiment of the elastic menu strip in a vertical orientation.

FIG. 6 provides a block diagram describing a system architecture of an embodiment of the present disclosure.

FIG. 7 provides a flowchart describing an embodiment of arranging the plurality of menu items.

FIG. 8 provides a flowchart describing an embodiment of controlling the plurality of menu items.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

In referring to the description, specific details are set forth in order to provide a thorough understanding of the examples disclosed. In other instances, well-known methods, procedures, components and materials have not been described in detail as not to unnecessarily lengthen the present disclosure.

It should be understood that if an element or part is referred herein as being “on”, “against”, “in communication with”, “connected to”, or “coupled to” another element or part, then it can be directly on, against, in communication with, connected or coupled to the other element or part, or intervening elements or parts may be present. When used, term “and/or”, includes any and all combinations of one or more of the associated listed items, if so provided.

The terminology used herein is for the purpose of describing particular embodiments only and is not intended to be limiting. As used herein, the singular forms “a”, “an”, and “the”, are intended to include the plural forms as well, unless the context clearly indicates otherwise. It should be further understood that the terms “includes” and/or “including”, when used in the present specification, specify the presence of stated features, integers, steps, operations, elements, and/or components, but do not preclude the presence or addition of one or more other features, integers, steps, operations, elements, components, and/or groups thereof not explicitly stated.

Some embodiments of the present invention may be practiced on a computer system that includes, in general, one or a plurality of processors for processing information and instructions, RAM, for storing information and instructions, ROM, for storing static information and instructions, a data storage unit such as a magnetic or optical disk and disk drive for storing information and instructions, modules as software units executing on a processor, an optional user output device such as a display screen device (e.g., a monitor) for display screening information to the computer user, and an optional user input device.

As will be appreciated by those skilled in the art, the present examples may be embodied, at least in part, a computer program product embodied in any tangible medium of expression having computer-usable program code stored therein. For example, some embodiments described below with reference to flowchart illustrations and/or block diagrams of methods, apparatus (systems) and computer program products can be implemented by computer program instructions. The computer program instructions may be stored in computer-readable media that can direct a computer or other programmable data processing apparatus to function in a particular manner, such that the instructions stored in the computer-readable media constitute an article of manufacture including instructions and processes which implement the function/act/step specified in the flowchart and/or block diagram. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In the following description, reference is made to the accompanying drawings which are illustrations of embodiments in which the disclosed invention may be practiced. It is to be understood, however, that those skilled in the art may develop other structural and functional modifications without departing from the novelty and scope of the instant disclosure.

Generally, the present invention concerns a device, a method, and a computerized user interface, such as a display, screening menu items on a computerized user interface. In addition the present invention provides a user a computerized user interface to control the menu items. The menu items may be displayed in an elastic menu strip which may be extended to provide additional number of menu items upon user's request. These and other objectives of the present invention would be obvious to those of ordinary skill in the art by the following description of the present invention and its preferred embodiments.

Storage unit contemplated herein may be in the format including, but are not limiting to, XML, JSON, CSV, binary, over any connection type: serial, Ethernet, etc. over any protocol: UDP, TCP, and the like.

Computer or computing device contemplated herein may include, but are not limited to, virtual systems, Cloud/remote systems, desktop computers, laptop computers, tablet computers, handheld computers, smart phones and other cellular phones, and similar internet enabled mobile devices, digital cameras, a customized computing device configured to specifically carry out the methods contemplated in this disclosure, and the like.

The display screen contemplated herein may include, but are not limited to, LED screen, LCD screen, Plasma screen, touchscreen, proximity sensor-enabled screen, and the like.

The user input pointing device contemplated herein may include, but are not limited to, a mouse, a touchpad, a mouse pad, a track point, a trackball, a 3D-mouse, a joystick, a pointing stick, a finger tracking device, a proximity sensor input device, and the like.

The terms “controller” and “processor” contemplated herein are interchangeable, and refer to a central processing unit, a microprocessor, a microcontroller, a microcomputer, a programmable logic controller, and the like.

Network contemplated herein may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. Network may include multiple networks or sub-networks, each of which may include, for example, a wired or wireless data pathway. The network may include a circuit-switched voice network, a packet-switched data network, or any other network able to carry electronic communications. Examples include, but are not limited to, Picture Transfer Protocol (PTP) over Internet Protocol (IP), IP over Bluetooth, IP over WiFi, and PTP over IP networks (PTP/IP).

Menu items contemplated herein refers to computerized graphical object on a display screen. Menu items may include, but not limited to, icons, text item, and the like.

A system for presenting a plurality of menu items on a display screen is provided. The system may comprise a computerized system with one or more processors, one or more computerized user interfaces in communication with the one or more processors, a user input pointing device, and a storage unit accessible by the one or more processors via a network. The system may comprise one or more computers or computerized elements in communication working together to carry out the different functions of the system. The invention contemplated herein further may comprise a storage unit, such as a non-transitory computer readable media configured to instruct a computer or computers to carry out the steps and functions of the system and method, as described herein. In some embodiments, the communication among the one or more computer or the one or more processors alike, may support a plurality of encryption/decryption methods and mechanisms of various types of data.

The computerized user interface may be in communication with one or more computing devices in networked communication with each other. The computer or computers of the computerized user interface contemplated herein may comprise a memory, processor, and input/output system. In some embodiments, the computer may further comprise a networked connection and/or a display screen. These computerized elements may work together within a network to provide functionality to the computerized user interface. The computerized user interface may be any computerized interface capable of allowing a user to input data and receive a feedback. The computerized user interface may further provide outputs executed by the system contemplated herein.

A computing device for presenting a plurality of menu items on a display screen is provided. The computing device may comprise a display screen, one or more processors, a storage unit with one or more programs stored therein. The one or more programs may be stored in the storage unit causing the computing device to execute the one or more programs for performing multiple functions in conjunction with the computing device. The one or more program may comprise instruction that, when executed, presents a user to control a computerized user interface, which includes the plurality of menu items being displayed on the display screen.

In one embodiment, the display screen may be coupled to the one or more processors to present the user the computerized user interface on the display screen of the computing device. The display screen may further be coupled to the storage unit and the one or more processors for controlling the display screen's functions. The computer readable storage medium may comprise instructions to modify the display screen of the plurality of menu items based on the user's interaction with the display screen. The plurality of menu items may be of any type of computerized graphical objects, or commonly called as icons. By way of example, the plurality of menu items may include icons, such as “internet”, “messages”, “e-mail” or the like.

In another embodiment, the display screen may further be coupled to a detector unit. The detector unit in communication with the one or more processors may monitor, receive inputs, and track movement of a cursor of the user input pointing device.

Each of the plurality of menu items may correspond to a function of the computing device, an application, or a program stored in the storage unit to execute a set of instruction designated to an application or a program. The user may interact with the computerized user interface by utilizing a user input pointing device. The user input pointing device may enable the user to initiate various functions and features of the computing device, for each of the plurality of menu items.

Certain cursor actuations initiated by the user input pointing device may trigger the one or more processors to initiate the various functions and features linked to each of the plurality of menu items. The detector unit may be in communication with the one or more processors, monitoring a cursor of the user input pointing device to detect cursor actuations from the user input pointing device. By way of example, right clicking of a menu item (cursor actuation) with a mouse button may launch the application corresponding to the menu item clicked. A finger making contact, for example tapping (cursor actuation), with a menu item presented on a touch screen may launch the application corresponding to the menu item being selected by the finger. These and any other various functions and features corresponding to the menu item may be carried out by the system and its components described herein.

A method of presenting a plurality of menu items on a display screen in accordance with the computing device described above is provided. The computerized user interface on the computing device is presented on the display screen, coupled to the one or more processors. The one or more processors may implement the computer-implemented methods executable by the one or more programs. According to the method, the user may interact with the computerized user interface (for example, a display screen) by utilizing the user input pointing device to control the plurality of menu items.

The display screen may comprise a menu activation area displayed on the display screen. When the menu activation area is triggered by the user, the plurality of menu items may be presented on the display screen as part of the computerized user interface. In one embodiment, the user may trigger the menu activation area by moving the user input pointing device. The user may control the user input pointing device to place a cursor of the user input pointing device at a desired location. Cursor contemplated herein is an indicator that shows the location of the user input pointing device on the display screen. Cursor-to-user input pointing pair may include, but not limited to, pointer to mouse, finger contact to touch screen, and the like. When the user places the cursor on the menu activation area, thereby triggering the menu activation area, the plurality of menu items may be activated, thus presented on the display screen.

In some embodiments, the method and system described herein may involve a touch screen device, where contact made by a finger from a user is the user input pointing device. In one embodiment, the touch screen device may require a minimal cursor actuations from the user input pointing device. Once the initial contact is made by the finger to select an icon or other area of the display screen, the subsequent action may be triggered by lifting of the finger. By way of example, the touch screen device may detect the finger being on the menu activation area, as such the one or more processors presents the plurality of menu items in the elastic menu strip. The detector unit may detect that the contact is being maintained while the finger moves to an overflow trigger. Once the finger (cursor) makes contact with the overflow trigger and lifts it, the overflow trigger may be activated. As such, the movements and cursor actuations required by the user input pointing device is reduced. This embodiment may be applied to other available user input pointing devices in a similar manner.

In another embodiment, the menu activation area may be visually labeled to assist the user the location of the menu activation. By way of example, the menu activation area may be highlighted, animated, or dynamically positioned to assist the user to identify the location of the menu activation area on the display screen.

The plurality of menu items may be presented on the display screen in certain arrangements. The plurality of menu items may be arranged in various orientations, providing various computerized graphical presentations of the plurality of menu items on the display screen. In one embodiment, the plurality of menu items may be arranged horizontally with respect to the user view point. In another embodiment, the plurality of menu items may be arranged vertically with respect to the user view point.

The plurality of menu items may be arranged in various orientations based on, but not limiting to, the size of each of the plurality of menu items, the availability of the display screen, the size of the display screen, the number of the plurality of menu items, and the orientation of the display screen. The orientation or visual presentation of the plurality of menu items may be presented in accordance with the function of the computing device, an application or a program stored in the computer readable storage medium. Those of ordinary skill in the art would appreciate that each of the plurality of menu items may be arranged and presented on the display screen in many different ways.

The user may further select each of the plurality of menu items to initiate the various functions and features of the programs stored in the computing device, corresponding to each of the plurality of menu items. The user may utilize the user input pointing device to make a selection.

The plurality of menu items may be presented within an elastic menu strip. The elastic menu strip may set a frame where the plurality of menu items is contained. The elastic menu strip may further comprise an overflow trigger placed along with the plurality of menu items. Once the user activates the overflow trigger, the elastic menu strip may extend to present a plurality of additional menu items on the display screen that were not presented before such activation. The plurality of additional menu items may be contained by an additional elastic menu strip. The additional elastic menu strip may be presented as an extension to the elastic menu being extended. The quantity of the plurality of additional menu items being presented may be determined based on the size of each of the plurality of menu items and additional menu items, the spacing among each of the plurality of menu items and additional menu items, the size of the display screen, availability of the display screen, the orientation of the display screen, the number of the plurality of menu items and additional menu items, and the resolution of the display screen.

In one embodiment, the elastic menu strip may extend by presenting additional rows or columns of the plurality of additional menu items adjacent to the plurality of menu items.

In another embodiment, the overflow trigger may be omitted if there is no additional menu items to be presented on the display screen.

In yet another embodiment, once the user activates the overflow trigger, the plurality of menu items within the elastic menu strip may be replaced with the plurality of additional menu items, partially or entirely.

In a further embodiment, the additional elastic menu strip may be added as an extension to the elastic menu strip towards the available area in the display screen.

In a further embodiment, the additional elastic menu strip may be added as an extension to the elastic menu strip around at least a portion of a perimeter of the display screen.

The user may activate the overflow trigger in various ways. In one embodiment, activation of the overflow trigger may be achieved when the user places the cursor on the overflow trigger and selects the overflow trigger. The selection may be executed by clicking the user input pointing device or tapping the display screen if the display screen is a touchscreen. In another embodiment, the activation of the overflow trigger may be achieved when the user places the cursor on the overflow trigger for a predetermined duration of time. The predetermined duration of time may be reprogrammable by editing the one or more programs stored within the computer readable storage medium.

When the user activates the elastic menu strip by triggering the menu activation area, the location of the elastic menu strip being presented on the display screen may vary. In one embodiment, the elastic menu strip may be placed at a predetermined location of the display screen. Similar to the aforementioned orientation of the plurality of menu items, the elastic menu strip may be placed in various orientations, such as vertical, horizontal, and diagonal. The predetermined location on the display screen may be assigned an x-y coordinates within the display screen, stored in the computer readable storage medium.

In another embodiment, the elastic menu strip or the additional elastic menu strip may have a predetermined frame size. The predetermined frame size of the elastic menu may be stored in the computer readable storage medium assigned with the x-y coordinates within the display screen and a shape of the frame. Similarly, the elastic menu strip or the additional elastic menu strip may be presented within a designated area of the display screen. The designated area may be predetermined, limiting the sizing and positioning of the elastic and additional elastic menu strips.

In yet another embodiment, the elastic menu strip or the additional elastic menu strip may be placed at the nearest location from the cursor to minimize the distance the cursor needs to travel to reach the elastic menu strip, thereby providing higher usability. The location of the cursor from the user input pointing device may be calculated by determining the cursor's location in x-y coordinates with regards to the display screen. The display screen coupled to the one or more processors may track the movement and location of the cursor in real-time with the detector unit in communication with the one or more processors. By way of example, a computing device with a touchscreen may comprise the detector unit that tracks the movement of the user's finger. In one embodiment, the computing device may comprise a proximity sensor to track the movement of the user's finger near the display screen.

The elastic menu strip or the additional elastic menu strip may be applicable to various applications and programs in the computing device, such that the elastic menu strip is intuitive and adjustable per various circumstances of the applications and the programs.

In a further embodiment, the elastic menu strip or the additional elastic menu strip may be repositioned as the user moves the cursor. Once the cursor is within the elastic menu strip, the detector unit may track and follow the movement of the cursor, unless the cursor is placed on one of the plurality of menu items or one of the plurality of additional menu items to further execute the corresponding programs or applications.

Once the overflow trigger is activated, the elastic menu strip is at an overflow state. While at the overflow state, the elastic menu strip may further comprise an exit trigger. Similar to the operation of the overflow trigger, the user may place the cursor on the exit trigger to exit out of the overflow state. When the overflow trigger is activated, the additional elastic menu strip may be presented on the display screen. In one embodiment, placing the cursor on an inactive area may also cancel the activation of the overflow state, thereby exiting out of the overflow state.

The plurality of menu items may be removed from the display screen by deactivating the plurality of menu items. In one embodiment, the plurality of menu items or the elastic menu strip may be deactivated by simply placing the cursor to an inactive area of the display screen. The inactive area may be placed at a predetermined location within the display screen or any area within the display screen. In another embodiment, the plurality of menu items or the elastic menu strip may be deactivated, once the user selects one of the plurality of menu items or one of the plurality of additional menu items.

The computerized user interface may further be visualized by placing a help text bubble. Each of the plurality of menu items, each of the plurality of additional menu items, the overflow trigger, the menu activation area, and the inactive area may prompt the help text bubble once the user interacts with the computerized user interface. The help text bubble may visually assist the user and provide guidance in operation of the present invention.

The present disclosure enables, among other things, the user to interact with the display screen of the computing device to control or manage the plurality of menu items with ease. In one embodiment, the method for controlling the plurality of menu items may be executed with the user continuously making contact with the touchscreen by utilizing a finger as the user input pointing device. In this embodiment, the user may trigger the menu activation area by placing the finger on the menu activation area of the display screen. Once the plurality of menu items are presented on the display screen, the user may further select one of the plurality of menu items by simply dragging the finger from the menu activation area to the one of the plurality of menu items. Similarly, the user may select the overflow trigger or the exit trigger by, again, dragging the finger from the menu activation area to the overflow trigger or the exit trigger, without taking the finger away from the touchscreen.

The following exemplary embodiments are described in connection with the figures submitted herewith and with regards to the description of the present invention disclosed above.

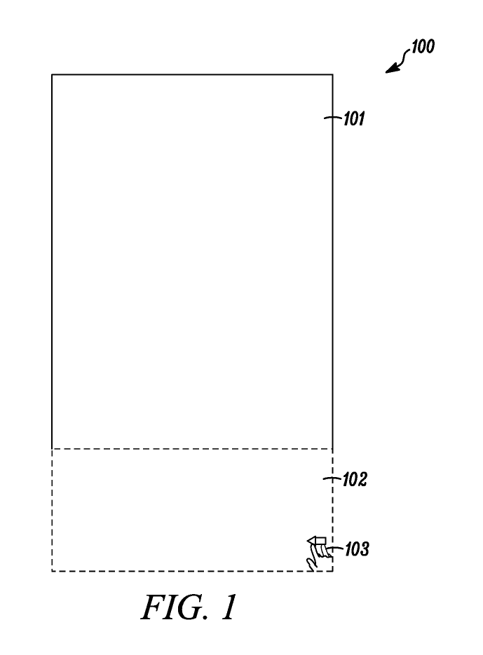

Turning now to FIG. 1, FIG. 1 shows an embodiment of the display screen being presented by a computing device. The computerized user interface 100 provided in this exemplary embodiment shows the display screen 101 including the menu activation area 102. The menu activation area 102 shows a help bubble 103 to notify the user of its location. Once the user interacts with the menu activation area 102 with the user input pointing device, the plurality of menu items or the elastic menu strip may appear on the display screen 101.

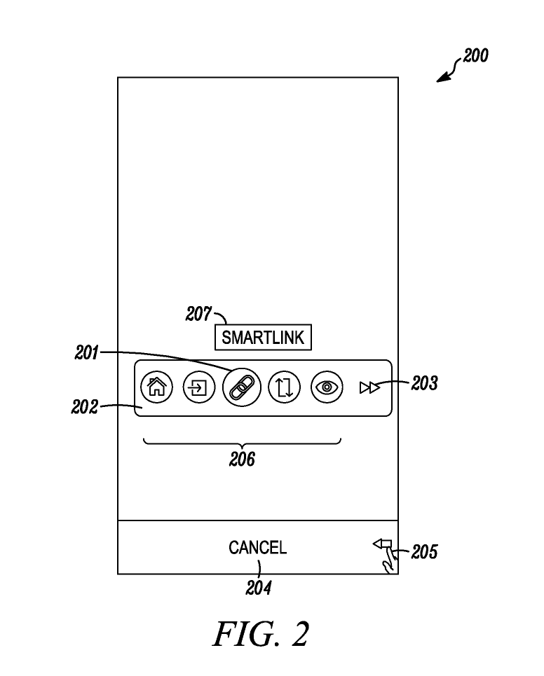

FIG. 2 shows a screenshot of the elastic menu strip being displayed on the display screen. The display screen 200 presents the elastic menu strip 202, the overflow trigger 203, the inactive area 204 and the menu activation area 205. The help text bubble 207 is shown above one of the plurality of menu items 201 “SMARTLINK” contained within the frame of the elastic menu strip 202. The one 201 of the plurality of menu items 206 is shown here as selected by the cursor via the user input pointing device which shows a solid color scheme to notify the user that the selection has been made. The help text bubble notifies on the display screen that the selection is being made.

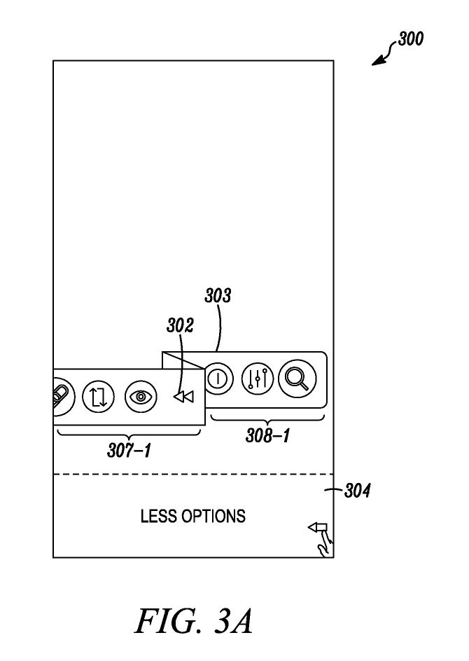

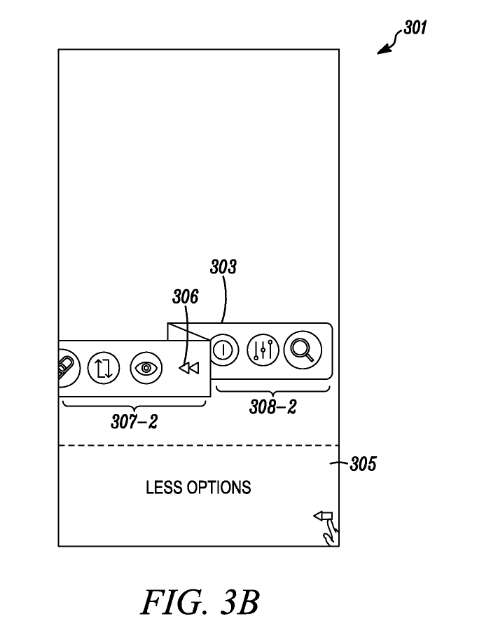

FIG. 3A and 3B show exemplary embodiments of the elastic menu strip in the overflow state. The display screen 300 301 contains the elastic menu strip being at the overflow state 303. In this embodiment, the display screen presents the elastic menu strip that is folded twice to bring in the plurality of additional menu items 308-1 308-2 that were not shown prior to the activation of the overflow trigger. The plurality of additional menu items 308-1 308-2 are presented on the additional elastic menu strip. The plurality of menu items 307-1 307-2 are contained within the elastic menu strip. The exit triggers 302 306 are shown, which when activated, exits the elastic menu strip out from the overflow state. The inactive area 304 and 305 are shown. In response to detecting the cursor at the inactive area, the system may exit out of the overflow state. The difference in vertical heights of the two inactive areas are presented to show an exemplary embodiment of how the elastic menu strip is adjustable based on the user's cursor location.

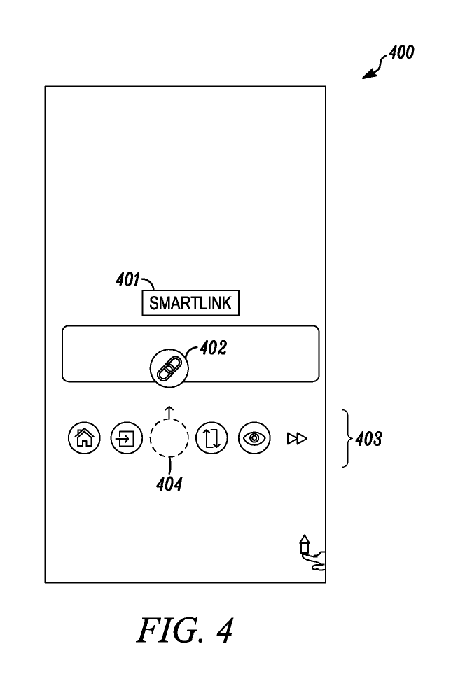

FIG. 4 illustrates one of the plurality of menu items being selected from the elastic menu strip. In this exemplary embodiment, the display screen 400 shows the plurality of menu items 403 being separated away from selected menu item 402 to confirm the user that the selection has been made. The help text bubble 401 is also shown. As the item 402 is selected by the user input point device or the cursor, it is separated away from its original location 404. In this exemplary embodiment, the display screen may be a touchscreen which is operated by a user's finger as the user input pointing device.

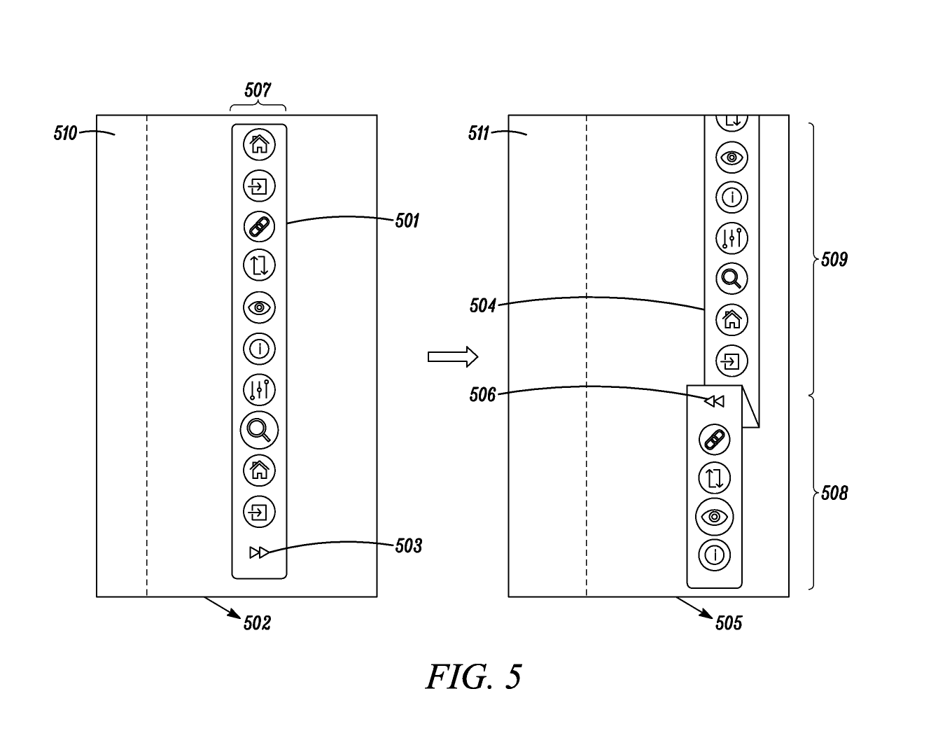

FIG. 5 shows an exemplary embodiment of the elastic menu strip in a vertical orientation with respect to the user's point of view. The elastic menu strip 501 is presented on the display screen 502 as a graphical computerized user interface. In this embodiment, the display screen 502 is in connection with a touchscreen device. The elastic menu strip 501 includes the overflow trigger 503 and the plurality of menu items 507. The display screen includes the inactive area 510. Once the user activates the overflow trigger 503, the elastic menu strip enters the overflow state. The display screen 505 shows the elastic menu strip 504 at the overflow state. In this embodiment, the elastic menu strip 504 is vertically folded twice to bring in the plurality of additional menu items within the additional elastic menu strip 508 as the extension to the elastic menu strip 509, which were not shown prior to the activation of overflow trigger. The exit trigger 506 is shown, which when triggered, exits the elastic menu strip out from the overflow state. Alternatively, the inactive area 511 may be triggered to exit out of the overflow state.

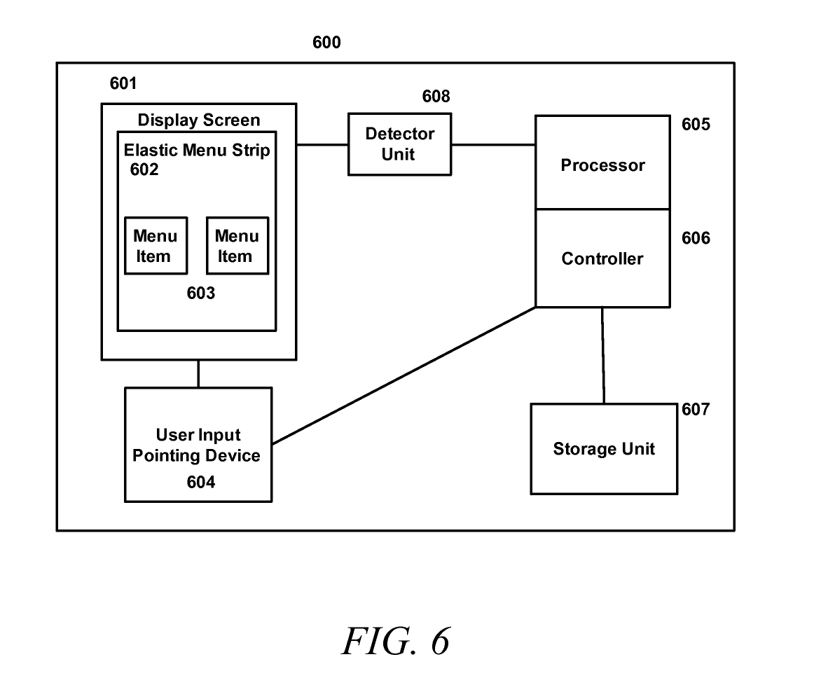

FIG. 6 describes a block diagram describing an overall system architecture for carrying out the method of the present disclosure. The computing device 600 comprises a display screen 601, a processor 605, a storage unit 607, a detector unit 608, and a user input pointing device 604. The processor may further be in communication with a controller 606. The controller may be designed to perform a specific task for the display screen or the user input pointing device. The terms processor and controller are interchangeably used herein. The display screen 601 is coupled to the detection unit 608 which may monitor, receive inputs, such as cursor actuation, from the user input pointing device 604, and track movements of the cursor on the display screen. The display screen 601 further contains the elastic menu strip 602 which in turn contains the plurality of menu items 603. The processor is electronically in communication with the display screen, the user input pointing device, and the storage unit. The processor 605 translates the user's control of the user input pointing device 604 such as a finger contact or a cursor on to the display screen 601. The storage unit 607 comprises a plurality of programs which contains instructions to modify the menu items being displayed on the display screen 601. The system architecture of the computing device shown here would be understandable to those of ordinary skill in the art and applicable in various computing device and common operating systems.

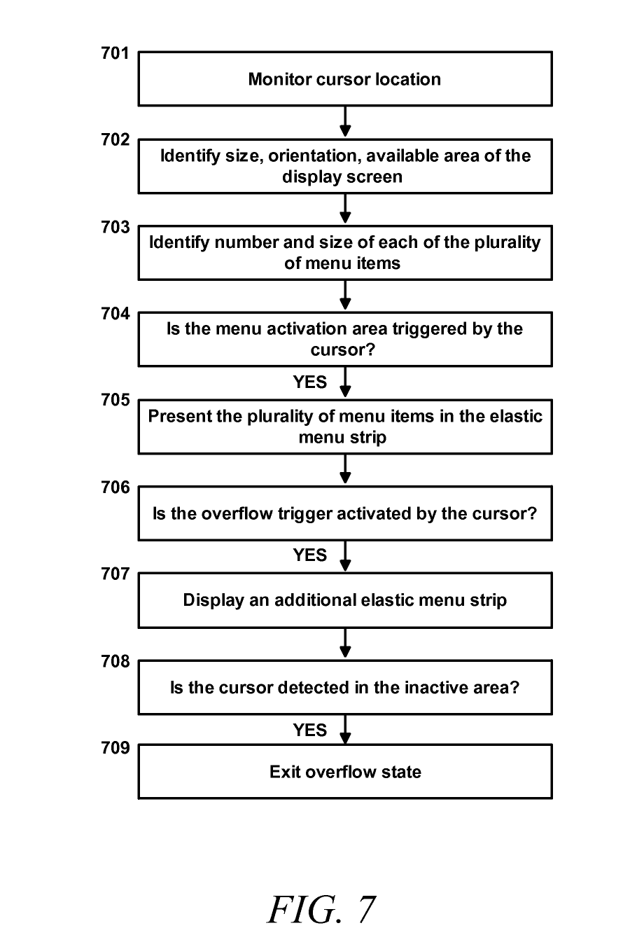

FIG. 7 provides a flowchart describing an embodiment of arranging the plurality of menu items. The one or more processors may begin the process by monitoring the cursor location of the user input pointing device 701 with the detector unit. The size, orientation, and available area of the display screen may be detected by the one or more processors 702. The available area of the display screen may be a portion of the display screen where no icons or graphical elements are present. Each of the plurality of menu items being stored by the storage unit may all be assigned with size or orientation. Further, the one or more processors may identify the number of the plurality of menu items 703. Depending on the parameters of the display screen above and the parameters of the plurality of menu items, the size or orientation of the elastic menu strip may be determined. At 704, the one or more processors may display the plurality of menu items in the elastic menu strip 705 in response to the menu activation area being triggered by the cursor. The additional elastic menu may appear on the display screen 707, if the overflow trigger is activated by the cursor 706. In order to exit out from the overflow state 709 or to deactivate the additional elastic menu strip, the one or more processors may determine whether the cursor is detected in the inactive area or not. If yes, the display screen may exit the overflow state.

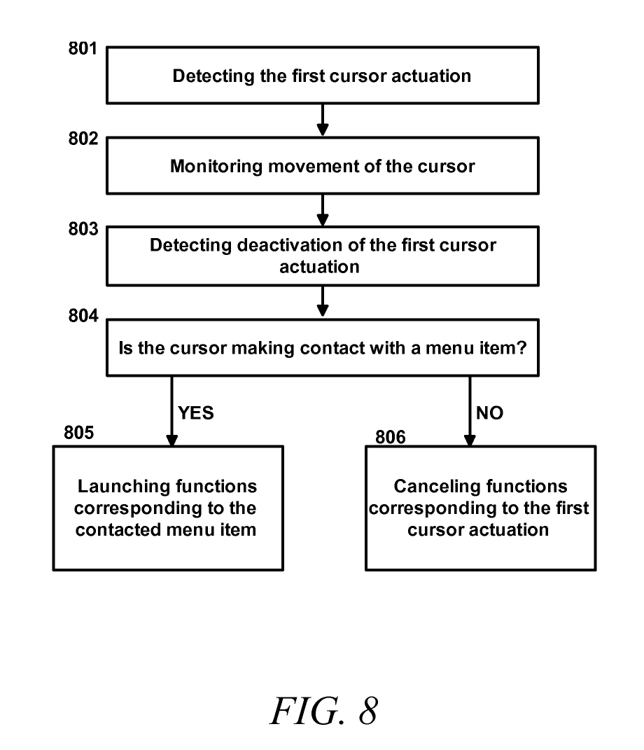

FIG. 8 provides a flowchart describing an embodiment of controlling the plurality of menu items. The control of the cursor actuations may be simplified by reducing the number of cursor actuations it takes to perform a function of feature in the computing device including the display screen. At step 801, the first cursor actuation is detected by the detector unit. The first cursor actuation may be of any action that triggers or activates a subsequent action performed by the program or application. For example, a click by a mouse or a tap by a finger on a menu item starts the application linked to the menu item. At step 802, the one or more processors in communication with the detector unit monitors the movement of the cursor on the display screen. When the first cursor actuation is deactivated 803, the one or more processors may determine if the cursor is making any contact with a menu item 804 at the location of the cursor actuation being deactivated. For example, lifting a finger of a touchscreen indicates a termination of a cursor actuation (i.e. making contact with the touchscreen). If the cursor is in contact with the menu item, functions corresponding to the menu item is triggered and launched 805. If the cursor is not in contact with the menu item, the first cursor actuation is cancelled and the corresponding functions is terminated 806.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

Those skilled in the art will readily observe that numerous modifications, applications and alterations of the device and method may be made while retaining the teachings of the present invention.

What is claimed is:

1. A method of presenting a plurality of menu items on a display screen of a computing device, the method comprising the steps of:
presenting, by one or more processors, the plurality of menu items on the display screen, in response to a menu activation area being triggered, the display screen comprising the menu activation area, wherein the menu activation area is triggered in response to detecting, with a detector unit, a first cursor actuation from a cursor of a user input pointing device at the menu activation area, the user input pointing device and the detector unit in communication with the one or more processors;
arranging, by the one or more processors, the plurality of menu items on the display screen, wherein the plurality of menu items are arranged within an elastic menu strip, the elastic menu strip being sized and positioned on the display screen based on at least one of:
size of the display screen;
orientation of the display screen;
available area of the display screen;
number of the plurality of menu items; and
size of each of the plurality of menu items; and
displaying, by the one or more processors, an additional elastic menu strip by adding the additional elastic menu strip as an extension to the elastic menu strip to present at least one additional menu item contained within the additional elastic menu strip on the display screen, in response to an overflow trigger being activated, the plurality of menu items comprising the overflow trigger, the overflow trigger being activated by monitoring the cursor of the user input pointing device.

2. The method of claim 1 wherein the step of displaying an additional elastic menu strip comprises presenting the additional elastic menu strip by at least one of:
adding the additional elastic menu strip along and adjacent to the elastic menu strip;
adding the additional elastic menu strip around at least a portion of a perimeter of the display screen;
adding the additional elastic menu strip towards the available area of the display screen; and
replacing at least a portion of the elastic menu strip with the additional elastic menu strip.

3. The method of claim 1 wherein the overflow trigger is activated in response to at least one of:
the cursor being detected by the detector unit on the overflow trigger;
the overflow trigger being selected by the cursor; and
the cursor being detected by the detector unit on the overflow trigger for a predetermined duration of time.

4. The method of claim 1 further comprising the steps of:
detecting a first location of the cursor on the display screen with the detector unit; and
positioning the elastic menu strip at the first location.

5. The method of claim 4 further comprising the steps of:
detecting the cursor, with the detector unit, moving from the first location to a second location on the display screen; and
repositioning the elastic menu strip from the first location to the second location.

6. The method of claim 1 further comprising the step of deactivating the overflow trigger in response to at least one of:
triggering of an exit trigger by the cursor, the additional elastic menu strip comprising the exit trigger; and
the cursor being detected by the detector unit in an inactive area, the display screen comprising the inactive area.

7. The method of claim 1 wherein the overflow trigger is activated when the first cursor actuation is maintained by the user input pointing device until the cursor makes contact with the overflow trigger, the detector unit monitoring movement of the cursor of the user input pointing device.

8. The method of claim 7 further comprising the step of triggering a menu item from the additional elastic menu strip to execute a function of an application corresponding to the menu item, wherein the menu item is triggered when the first cursor actuation is maintained by the user input pointing device until the cursor makes contact with the menu item and the first cursor actuation is terminated.

9. The method of claim 1 further comprising the step of triggering a menu item from the elastic menu strip to execute a function of an application corresponding to the menu item, wherein the menu item is triggered when the first cursor actuation is maintained by the user input pointing device until the cursor makes contact with the menu item and the first cursor actuation is terminated, the detector unit monitoring movement of the cursor of the user input pointing device.

10. A device for presenting a plurality of menu items, the device comprising:
a display screen;
a storage unit storing an instruction; and
one or more processors in communication with the display screen and the storage unit, executing the instruction in the storage unit to:
present the plurality of menu items on the display screen, in response to a menu activation area being triggered, the display screen comprising the menu activation area, wherein the menu activation area is triggered in response to detecting, with a detector unit, a first cursor actuation from a cursor of a user input pointing device at the menu activation area, the user input pointing device and the detector unit in communication with the one or more processors;
arrange the plurality of menu items on the display screen, wherein the plurality of menu items are arranged within an elastic menu strip, the elastic menu strip being sized and positioned on the display screen based on at least one of:
size of the display screen;
orientation of the display screen;
available area of the display screen;
number of the plurality of menu items; and
size of each of the plurality of menu items; and
display an additional elastic menu strip by adding the additional elastic menu strip as an extension to the elastic menu strip to present at least one additional menu item contained within the additional elastic menu strip on the display screen, in response to an overflow trigger being activated, the plurality of menu items comprising the overflow trigger, the overflow trigger being activated by monitoring the cursor of the user input pointing device.

11. The device of claim 10 wherein the additional elastic menu strip is displayed by at least one of:
adding the additional elastic menu strip along and adjacent to the elastic menu strip;
adding the additional elastic menu strip around at least a portion of a perimeter of the display screen;
adding the additional elastic menu strip towards the available area of the display screen; and
replacing at least a portion of the elastic menu strip with the additional elastic menu strip.

12. The device of claim 10 wherein the overflow trigger is activated in response to at least one of:
the cursor being detected by the detector unit on the overflow trigger;
the overflow trigger being selected by the cursor; and
the cursor being detected by the detector unit on the overflow trigger for a predetermined duration of time.

13. The device of claim 10 wherein the one or more processors detects, with the detector unit, a first location of the cursor on the display screen, and positions the elastic menu strip at the first location.

14. The device of claim 13 wherein the one or more processors further detects the cursor moving from the first location to a second location on the display screen, and repositions the elastic menu strip from the first location to the second location.

15. The device of claim 10 wherein the one or more processors further deactivates the overflow trigger in response to at least one of:
triggering of an exit trigger by the cursor, the additional elastic menu strip comprising the exit trigger; and
the cursor being detected by the detector unit in an inactive area, the display screen comprising the inactive area.

16. The device of claim 10 wherein the overflow trigger is activated when the first cursor actuation is maintained by the user input pointing device until the cursor makes contact with the overflow trigger, the detector unit monitoring movement of the cursor of the user input pointing device.

17. The device of claim 16 wherein a function of an application corresponding to a menu item from the additional elastic menu strip is executed in response to the menu item being triggered, the menu item being triggered when the first cursor actuation is maintained by the user input pointing device until the cursor makes contact with the menu item and the first cursor actuation is terminated.

18. The device of claim 10 wherein a function of an application corresponding to a menu item from the elastic menu strip is executed in response to the menu item being triggered, the menu item being triggered when the first cursor actuation is maintained by the user input pointing device until the cursor makes contact with the menu item and the first cursor actuation is terminated, the detector unit monitoring movement of the cursor of the user input pointing device.

19. A non-transitory computer readable medium storing executable instructions which, when executed, cause one or more processors to perform the following steps for presenting a plurality of menu items on a display screen of a computing device, wherein the one or more processors is in communication with each other via a network, the one or more processors in communication with a storage unit, the steps comprising:
presenting, by one or more processors, the plurality of menu items on the display screen, in response to a menu activation area being triggered, the display screen comprising the menu activation area, wherein the menu activation area is triggered in response to detecting, with a detector unit, a first cursor actuation from a cursor of a user input pointing device at the menu activation area, the user input pointing device and the detector unit in communication with the one or more processors;
arranging, by the one or more processors, the plurality of menu items on the display screen, wherein the plurality of menu items are arranged within an elastic menu strip, the elastic menu strip being sized and positioned on the display screen based on at least one of:
size of the display screen;
orientation of the display screen;
available area of the display screen;
number of the plurality of menu items; and
size of each of the plurality of menu items; and
displaying, by the one or more processors, an additional elastic menu strip by adding the additional elastic menu strip as an extension to the elastic menu strip to present at least one additional menu item contained within the additional elastic menu strip on the display screen, in response to an overflow trigger being activated, the plurality of menu items comprising the overflow trigger, the overflow trigger being activated by monitoring the cursor of the user input pointing device.

20. The non-transitory computer readable medium of claim 19 further comprising the step of deactivating the overflow trigger in response to at least one of:
triggering of an exit trigger by the cursor, the additional elastic menu strip comprising the exit trigger; and
the cursor being detected by the detector unit in an inactive area, the display screen comprising the inactive area.
